(19) United States
(12) Patent Application Publication
(10) Pub. No.: US 2015/0296227 A1
(43) Pub. Date: Oct. 15, 2015

(54) DISPLAY APPARATUS AND DISPLAY METHOD THEREOF

(71) Applicants: Hyundai Motor Company, Seoul (KR); Hyundai Mobis Co., Ltd., Seoul (KR); KAI Media Co., Daejeon (KR)

(72) Inventors: Jong Ha Moon, Seoul (KR); Min Suk Lee, Daejeon (KR); Soo Il Chae, Daejeon (KR); Yong Joon Lee, Seoul (KR); Young Il Lee, Daejeon (KR)

(21) Appl. No.: 14/453,892

(22) Filed: Aug. 7, 2014

(30) Foreign Application Priority Data
Apr. 9, 2014 (KR) 10-2014-0042520

(51) Int. Cl. H04N 21/2365; H04N 21/234

(52) U.S. Cl. CPC H04N 21/2365; H04N 21/23424

(57) ABSTRACT

A display apparatus includes: a first communication unit configured to receive first multimedia data and identification information of the first multimedia data through a first communication network; an address generator configured to generate access addresses of second multimedia data using the identification information; a second communication unit configured to receive the second multimedia data from the access addresses through a second communication network; an image processor configured to combine the first multimedia data and the second multimedia data so as to generate third multimedia data; and a display configured to output the third multimedia data.

### CROSS-REFERENCE TO RELATED APPLICATION

This application is based on and claims the benefit of priority to Korean Patent Application No. 10-2014-0042520, filed on Apr. 09, 2014 in the Korean Intellectual Property Office, the invention of which is incorporated herein in its entirety by reference.

### TECHNICAL FIELD

The present invention relates to a display apparatus for receiving broadcast contents through a plurality of networks and a display method thereof.

### BACKGROUND

With the development of electronic technologies, various types of electronics have been developed and distributed. In particular, various types of display apparatuses such as TV, cellular phone, PC, notebook, and PDA have been frequently used in most families.

With the increase in a use of display apparatuses, users' demands for multi-functional, high-quality display apparatuses have increased. Recently, therefore, various types of apparatuses such as a set top box which may receive specific signals or provide high-performance functions such as high definition contents, high quality sound contents, and 3D contents have been developed.

In particular, in the case of the broadcast contents, the related art may normally receive a single content through one transmission channel; however, recently, the high definition contents and the high quality sound contents, the 3D contents, or the like may have a very large data size but may require a combination of a plurality of contents to view a single content. Therefore, to receive these contents, technologies of receiving contents through a plurality of networks have been developed.

In the case of receiving the contents through the plurality of networks, there is a need to receive data, which are associated with data received through one network, through another network. Therefore, the display apparatus needs to understand an accurate path through which the associated data (for example, additional data for high definition) are received.

Meanwhile, when the high definition contents are not normally received in some of the networks while the high definition contents received through the plurality of networks are played, low definition contents may be played. However, the user may not easily understand whether the currently playing contents are the low definition contents or the high definition contents.

### SUMMARY

The present invention has been made to solve the above-mentioned problems occurring in the prior art while advantages achieved by the prior art are maintained intact.

An aspect of the present invention provides a display apparatus for detecting a path through which second multimedia data associated with first multimedia data are received so as to receive the second multimedia data and a display method thereof.

Another aspect of the present invention provides a display apparatus for providing image quality information on currently playing contents to a user and a display method thereof.

According to an exemplary embodiment of the present invention, a display apparatus includes: a first communication unit configured to receive first multimedia data and identification information of the first multimedia data through a first communication network; an address generator configured to generate access addresses of second multimedia data using the identification information; a second communication unit configured to receive the second multimedia data from the access addresses through a second communication network; an image processor configured to combine the first multimedia data and the second multimedia data so as to generate third multimedia data; and a display configured to output the third multimedia data.

According to another exemplary embodiment of the present invention, a display method of a display apparatus includes: receiving first multimedia data and identification information of the first multimedia data through a first communication network; generating access addresses of second multimedia data using the identification information; receiving the second multimedia data from the access addresses through a second communication network; combining the first multimedia data and the second multimedia data so as to generate third multimedia data; and outputting the third multimedia data.

### BRIEF DESCRIPTION OF THE DRAWINGS

The above and other objects, features and advantages of the present invention will be more apparent from the following detailed description taken in conjunction with the accompanying drawings.

FIG. 1 is a block diagram illustrating a configuration of a broadcasting system according to an exemplary embodiment of the present invention;

FIG. 2 is a block diagram illustrating a configuration of a display apparatus according to an exemplary embodiment of the present invention; and

FIG. 3 is a flow chart illustrating a display method of a display apparatus according to an exemplary embodiment of the present invention.

### DETAILED DESCRIPTION

Hereinafter, exemplary embodiments of the present invention will be described in detail with reference to the accompanying drawings.

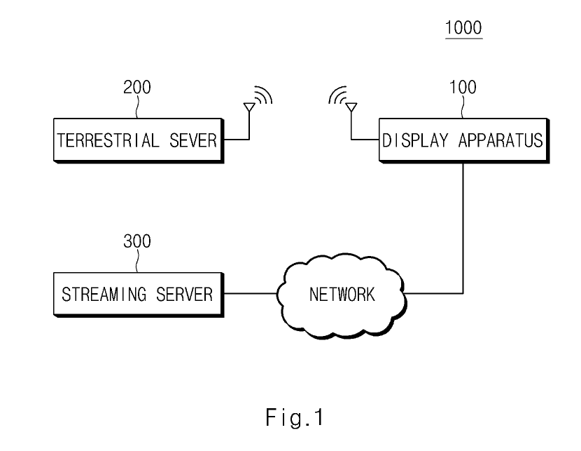

FIG. 1 is a block diagram illustrating a configuration of a broadcasting system according to an exemplary embodiment of the present invention.

Referring to FIG. 1, a broadcasting system 1000 may include a display apparatus 100, a terrestrial server 200, and a streaming server 300. The terrestrial server 200 may be connected to the display apparatus 100 through a first communication network. According to an exemplary embodiment of the present invention, the first communication network may be a terrestrial broadcasting network or a terrestrial DMB network. The streaming server 300 may be connected to the display apparatus through a second communication network. According to the exemplary embodiment of the present invention, the second communication network may be the Internet network.

According to the exemplary embodiment of the present invention, the display apparatus 100 may be connected to the second communication network through a mobile communication terminal (for example, smart phone, tablet PC). For example, the mobile communication terminal may be connected to the Internet network through a mobile communication network such as 3G and long term evolution (LTE) and the display apparatus 100 may be connected to the mobile communication terminal using a tethering or hotspot technology.

The terrestrial server 200 may transmit first multimedia data to the display apparatus 100 through the first communication network. The first multimedia data may be broadcast contents which are produced by a broadcasting station. According to the exemplary embodiment of the present invention, the first multimedia data may be low definition video data or left eye data or right eye data of 3D contents.

The terrestrial server 200 may transmit identification information of the first multimedia data along with the first multimedia data. According to the exemplary embodiment of the present invention, the identification information of the first multimedia data may be a transport stream identifier (TSID).

The streaming server 300 may transmit second multimedia data to the display apparatus 100 through the second communication network. According to the exemplary embodiment of the present invention, the second multimedia data may be additional video data which may increase an image quality of the first multimedia data or the left eye data or the right eye data of the 3D contents. According to the exemplary embodiment of the present invention, the streaming server 300 may transmit the second multimedia data in a streaming form.

The display apparatus 100 may receive the first multimedia data from the terrestrial server 200 through the first communication network. When a user receives broadcasting channels or contents, the display apparatus 100 may receive the first multimedia data corresponding to the selected broadcasting channels or the contents. The display apparatus 100 may receive the identification information of the first multimedia data from the terrestrial server 200 through the first communication network. According to the exemplary embodiment of the present invention, the display apparatus may receive the second multimedia data from the streaming server 300 through the second communication network.

According to the exemplary embodiment of the present invention, the display apparatus 100 may use the identification information received from the terrestrial server 200 to generate access addresses of the second multimedia data. According to the exemplary embodiment of the present invention, when the first multimedia data are received, the display apparatus 100 may determine whether the second multimedia data associated with the first multimedia data are present. If it is determined that the second multimedia data are present, the display apparatus 100 may generate the access addresses of the second multimedia data.

According to the exemplary embodiment of the present invention, the display apparatus 100 may store some of the access addresses of the second multimedia data. When the identification information is received, the display apparatus 100 may use the identification information to complete the access addresses of the second multimedia data.

According to the exemplary embodiment of the present invention, the access addresses of the second multimedia data are previously stored in the display apparatus 100 or may be received and stored from a server (not illustrated) through the second communication network.

The display apparatus 100 may receive the second multimedia data from the generated access addresses of the second multimedia data.

When the first multimedia data and the second multimedia data are received, the display apparatus 100 may combine the first multimedia data and the second multimedia data to generate third multimedia data. According to the exemplary embodiment of the present invention, the third multimedia data may be higher definition video data than the first multimedia data or 3D video data. When the third multimedia data are generated, the display apparatus 100 may output (or play) the third multimedia data.

According to the exemplary embodiment of the present invention, when the second vide data (for example, no connection to the second communication network or reduction in a receiving rate due to network traffic of the second communication network) are not normally received, the display apparatus 100 may play only the first multimedia data.

The display apparatus 100 may determine the image quality of the currently playing video data. According to the exemplary embodiment of the present invention, the display apparatus 100 may determine the image quality of the currently playing video data based on the amount of video data stored in a buffer in which the second multimedia data are stored. For example, when the data more than the preset amount are present in the buffer, it may be determined that the display apparatus 100 receives the second multimedia data to play the high definition image.

According to the exemplary embodiment of the present invention, the display apparatus 100 may determine the image quality of the currently playing video data based on the amount of video data stored in the buffer in which the third multimedia data are stored. For example, when the data more than the preset amount are present in the buffer, it may be determined that the display apparatus 100 generates the third multimedia data to play the high definition image. As another example, when the second multimedia data are not normally received, the third multimedia data may not be generated. Therefore, the first multimedia data subjected to the image processing may be stored in the buffer. When the data more than the preset amount are not present in the buffer (for example, when only the first multimedia data are stored), it may be determined that the display apparatus 100 plays the low definition image.

The display apparatus 100 may display the image quality information of the currently playing video data. According to the exemplary embodiment of the present invention, when the image quality of the playing video data is changed, the display apparatus 100 may display an object representing that the image quality of the video data is changed. According to the exemplary embodiment of the present invention, the object may include characters, icons, colors, contrast, and the like.

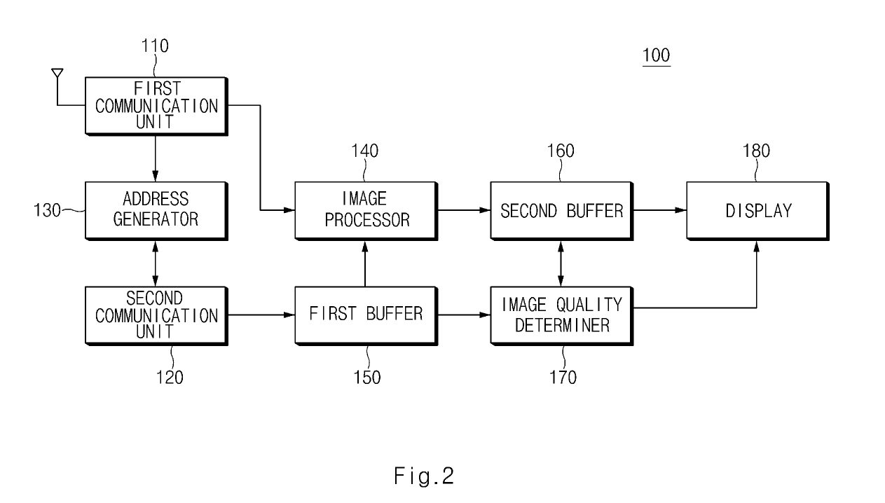

FIG. 2 is a block diagram illustrating a configuration of a display apparatus according to an exemplary embodiment of the present invention.

Referring to FIG. 2, the display apparatus 100 may include a first communication unit 110, a second communication unit 120, an address generator 130, an image processor 140, a first buffer 150, a second buffer 160, an image quality determiner 170, and a display 180.

The first communication unit 110 may receive the first multimedia data from the terrestrial server 200 through the first communication network. The first communication unit 110 may receive the identification information of the first multimedia data through the first communication network. According to an exemplary embodiment of the present invention, the first communication network may be the terrestrial broadcasting network or the terrestrial DMB network.

The second communication unit 120 may receive the second multimedia data from the streaming server 300. According to the exemplary embodiment of the present invention, the second communication network may be the Internet network. The second communication unit 120 may receive the second multimedia data from the access addresses of the second multimedia data of the streaming server 300. According to the exemplary embodiment of the present invention, the second communication unit 120 may receive the second multimedia data in the streaming form from the streaming server 300.

According to the exemplary embodiment of the present invention, the second communication unit 120 may be connected to the second communication network through mobile communication terminals (for example, smart phone, tablet PC). For example, the mobile communication terminal may be connected to the Internet network through the mobile communication network such as 3G and long term evolution (LTE) and the second communication unit 120 may be connected to the mobile communication terminal using the tethering or hotspot technology.

The address generator 130 may use the identification information of the first multimedia data to generate the access addresses of the second multimedia data. If it is determined that the second multimedia data are present, the display apparatus 100 may generate the access addresses of the second multimedia data.

The address generator 130 may use some of the prestored access addresses of the second multimedia data and the identification information to complete the access addresses of the second multimedia data. According to the exemplary embodiment of the present invention, the access addresses of the second multimedia data are previously stored in a storage unit (not illustrated) or may be received and stored from the server (not illustrated) through the second communication network.

The image processor 140 may receive the first multimedia data and the second multimedia data to process the image. According to the exemplary embodiment of the present invention, the image processor 140 may combine the first multimedia data and the second multimedia data to generate the third multimedia data. For example, the image processor 140 may receive the low definition first multimedia data and the second multimedia data which may improve the image quality of the first multimedia data to generate the high definition third multimedia data.

According to the exemplary embodiment of the present invention, when the second multimedia data are not normally received, the image processor 140 may perform image processing on the first multimedia data and output the processed first multimedia data.

The first buffer 150 may receive and store the second multimedia data from the second communication unit 120. The second multimedia data stored in the first buffer 150 may be output to the image processor 140.

The second buffer 160 may receive and store the first multimedia data or the third multimedia data from the image processor 140. For example, when the second multimedia data are normally received, the third multimedia data generated from the image processor 140 may be stored in the second buffer 160. When the second multimedia data are not normally received, the first multimedia data may be stored in the second buffer 160. The video data stored in the second buffer 160 may be output to the display 180.

The image quality determiner 170 may use the video data which are stored in the first buffer 150 or the second buffer 160 to determine the image quality of the currently playing video data.

According to the exemplary embodiment of the present invention, the image quality determiner 170 may determine the image quality of the currently playing video data based on the amount of video data stored in the first buffer. For example, when the data more than the preset amount are present in the first buffer 150, it may be determined that the image quality determiner 170 receives the second multimedia data to play the high definition image.

According to the exemplary embodiment of the present invention, the image quality determiner 170 may determine the image quality of the currently playing video data based on the amount of video data stored in the second buffer 160. For example, when the data more than the preset amount are present in the second buffer 160, it may be determined that the image quality determiner 170 generates the third multimedia data to play the high definition image. As another example, when the second multimedia data are not normally received, the third multimedia data may not be generated. Therefore, the first multimedia data subjected to the image processing may be stored in the second buffer 160. When the data more than the preset amount are not present in the second buffer 160 (for example, when only the first multimedia data are stored), it may be determined that the image quality determiner 170 plays the low definition image.

The display 180 may output the video data which are output from the image processor 140. For example, when the image processor 140 generates and outputs the third multimedia data, the display 180 may output the third multimedia data. As another example, when the second multimedia data are not normally received, the display 180 may output the first multimedia data.

According to the exemplary embodiment of the present invention, the display 180 may display the image quality information of the currently playing video data. According to the exemplary embodiment of the present invention, when the image quality of the playing video data is changed, the display 180 may display the object representing that the image quality of the video data is changed. According to the exemplary embodiment of the present invention, the object may include characters, icons, colors, contrast, and the like.

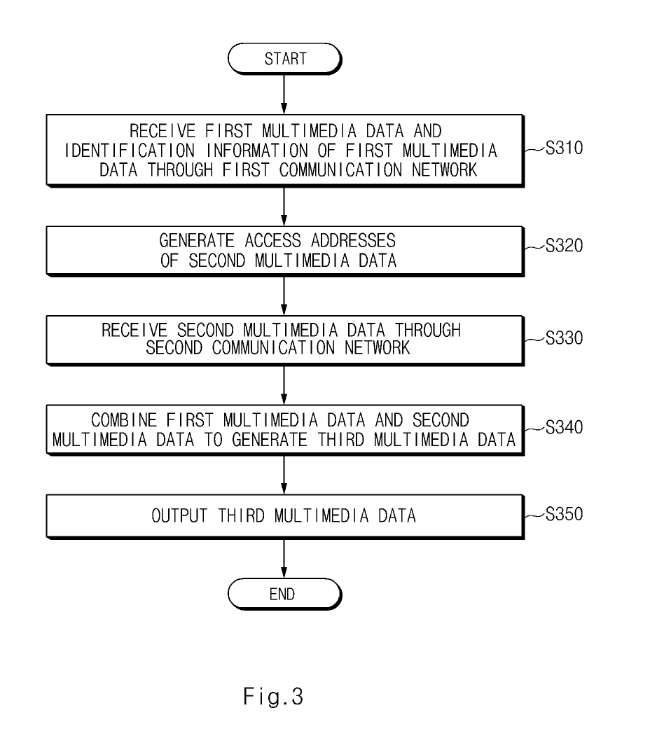

FIG. 3 is a flow chart illustrating a display method of a display apparatus according to an exemplary embodiment of the present invention.

Referring to FIG. 3, the display apparatus 100 may receive the first multimedia data and the identification information of the first multimedia data from the terrestrial server 200 through the first communication network (S310). According to an exemplary embodiment of the present invention, the first communication network may be the terrestrial broadcasting network or the terrestrial DMB network.

The display apparatus 100 may use the identification information to generate the access addresses of the second multimedia data (S320). According to the exemplary embodiment of the present invention, when the first multimedia data are received, the display apparatus 100 may determine whether the second multimedia data associated with the first multimedia data are present. If it is determined that the second multimedia data are present, the display apparatus 100 may generate the access addresses of the second multimedia data.

According to the exemplary embodiment of the present invention, the display apparatus 100 may store some of the access addresses of the second multimedia data. When the identification information is received, the display apparatus 100 may use the identification information to complete the access addresses of the second multimedia data.

According to the exemplary embodiment of the present invention, the access addresses of the second multimedia data are previously stored in the display apparatus 100 or may be received and stored from the server (not illustrated) through the second communication network.

The display apparatus 100 may receive the second multimedia data from the streaming server 300 (S330). According to the exemplary embodiment of the present invention, the second communication network may be the Internet network. According to the exemplary embodiment of the present invention, the display apparatus 100 may receive the second multimedia data in the streaming form from the streaming server 300.

According to the exemplary embodiment of the present invention, the display apparatus 100 may be connected to the second communication network through mobile communication terminals (for example, smart phone, tablet PC). For example, the mobile communication terminal may be connected to the Internet network through a mobile communication network such as 3G and long term evolution (LTE) and the display apparatus 100 may be connected to the mobile communication terminal using a tethering or hotspot technology.

The display apparatus 100 may combine the first multimedia data and the second multimedia data to generate the third multimedia data (S340). For example, the image processor 140 may receive the low definition first multimedia data and the second multimedia data which may improve the image quality of the first multimedia data to generate the high definition third multimedia data.

According to the exemplary embodiment of the present invention, when the second multimedia data are not normally received, the display apparatus 100 may perform the image processing on the received first multimedia data.

The display apparatus 100 may output the third multimedia data (S350). According to the exemplary embodiment of the present invention, when the second multimedia data are not normally received, the display apparatus 100 may output the first multimedia data.

According to the exemplary embodiment of the present invention, the display apparatus 100 may determine the image quality of the currently playing video data based on the amount of video data stored in the buffer in which the second multimedia data are stored. For example, when the data more than the preset amount are present in the buffer, it may be determined that the display apparatus 100 receives the second multimedia data to play the high definition image.

According to the exemplary embodiment of the present invention, the display apparatus 100 may determine the image quality of the currently playing video data based on the amount of video data stored in the buffer in which the first multimedia data or the third multimedia data are stored. For example, when the data more than the preset amount are present in the second buffer 160, it may be determined that the display apparatus 100 generates the third multimedia data to play the high definition image. As another example, when the second multimedia data are not normally received, the third multimedia data may not be generated. Therefore, the first multimedia data subjected to the image processing may be stored in the second buffer 160. When the data more than the preset amount are not present in the second buffer 160 (for example, when only the first multimedia data are stored), it may be determined that the image quality determiner 170 plays the low definition image.

The image quality determiner 170 may use the video data which are stored in the first buffer 150 or the second buffer 160 to determine the image quality of the currently playing video data.

According to the exemplary embodiment of the present invention, the image quality determiner 170 may determine the image quality of the currently playing video data based on the amount of video data stored in the first buffer. For example, when the data more than the preset amount are present in the first buffer 150, it may be determined that the image quality determiner 170 receives the second multimedia data to play the high definition image.

According to the exemplary embodiment of the present invention, the display apparatus 100 may display the image quality information of the currently playing video data. According to the exemplary embodiment of the present invention, when the image quality of the playing video data is changed, the display apparatus 100 may display the object representing that the image quality of the video data is changed. According to the exemplary embodiment of the present invention, the object may include characters, icons, colors, contrast, and the like.

As described above, according to the exemplary embodiments of the present invention, the display apparatus may receive the second multimedia data associated with the first multimedia data to play the high definition contents, the 3D contents, or the like. Further, according to the exemplary embodiments of the present invention, the image quality information of the currently playing contents may be provided to the user.

Hereinabove, although exemplary embodiments of the present invention are illustrated and described, the present invention is not limited to the aforementioned exemplary embodiment and it is apparent that various modifications can be made to those skilled in the art without departing from the spirit of the present invention described in the appended claims and the modified embodiments are not to be individually understood from the technical spirit and prospects of the present invention.

What is claimed is:

1. A display apparatus, comprising:
a first communication unit configured to receive first multimedia data and identification information of the first multimedia data through a first communication network;
an address generator configured to generate access addresses of second multimedia data using the identification information;
a second communication unit configured to receive the second multimedia data from the access addresses through a second communication network;
an image processor configured to combine the first multimedia data and the second multimedia data so as to generate third multimedia data; and
a display configured to output the third multimedia data.

2. The display apparatus according to claim 1, wherein the identification information is a transport stream identifier (TSID).

3. The display apparatus according to claim 1, wherein the third multimedia data is a higher definition video data than the first multimedia data.

4. The display apparatus according to claim 1, wherein when the second multimedia data are not received, the display outputs the first multimedia data.

5. The display apparatus according to claim 1, further comprising:
a buffer configured to store the second multimedia data; and
an image quality determiner configured to determine an image quality of currently playing video data based on the amount of video data stored in the buffer.

6. The display apparatus according to claim 1, further comprising:
a buffer configured to store data output from the image processor; and
an image quality determiner configured to determine an image quality of currently playing video data based on the amount of video data stored in the buffer.

7. The display apparatus according to claim 6, wherein the display displays image quality information of the currently playing video data.

8. The display apparatus according to claim 6, wherein when the image quality of the currently playing video data is changed, the display displays an object representing that the image quality of the video data is changed.

9. A display method of a display apparatus, comprising:
receiving first multimedia data and identification information of the first multimedia data through a first communication network;
generating access addresses of second multimedia data using the identification information;
receiving the second multimedia data from the access addresses through a second communication network;
combining the first multimedia data and the second multimedia data so as to generate third multimedia data; and
outputting the third multimedia data.

10. The display method according to claim 9, wherein the identification information is a transport stream identifier (TSID).

11. The display method according to claim 9, wherein the third multimedia data is a higher definition video data than the first multimedia data.

12. The display method according to claim 9, further comprising:
when the second multimedia data are not received, outputting the first multimedia data.

13. The display method according to claim 9, further comprising:
determining an image quality of currently playing video data based on the amount of video data stored in a buffer in which the second multimedia data are stored.

14. The display method according to claim 9, further comprising:
determining an image quality of currently playing video data based on the amount of video data stored in a buffer in which the first multimedia data or the third multimedia data are stored.

15. The display method according to claim 14, further comprising:
displaying image quality information of the currently playing video data.

16. The display method according to claim 14, further comprising:
when the image quality of the currently playing video data is changed, displaying an object representing that the image quality of the video data is changed.
